(19) United States
(12) Patent Application Publication
(10) Pub. No.: US 2006/0293107 A1
(43) Pub. Date: Dec. 28, 2006

(54) U-joint seal spring system

(75) Inventor: John Brian Wagner, Greenfield, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/365,906

(22) Filed: Mar. 1, 2006

Related U.S. Application Data
(63) Continuation-in-part of application No. 11/166,681, filed on Jun. 24, 2005.

(51) Int. Cl. F16D 3/16

(52) U.S. Cl. 464/133

(57) ABSTRACT

A U-joint system that advantageously allows for limited relative movement between the cups and the trunnions while avoiding excessive vibration. The U-joint system utilizes a biasing member, exhibiting either or both spring and damping characteristics, that is preloaded to create a desired axial stiffness between the cups and trunnions. The biasing member allows for limited relative movement between the cups and the trunnions during rotation of the U-joint system while avoiding excessive vibration.

### CROSS-REFERENCE TO RELATED APPLICATIONS

This application is a continuation-in-part of U.S. patent application Ser. No. 11/166,681 filed on Jun. 24, 2005. The disclosure of the above application is incorporated herein by reference.

### FIELD OF THE INVENTION

The present invention relates to biasing members, and particularly to biasing members in a U-joint system and methods for damping vibration of a U-joint assembly.

### BACKGROUND OF THE INVENTION

U-joint assemblies are used to couple rotating members together and accommodate rotation about intersecting axes. Each rotating member has a pair of yokes that are coupled together with U-joint assemblies. U-joint assemblies include a spider with four co-planar trunnions extending from a base and four cup assemblies secured to each of the trunnions. The cup assemblies utilize a seal to secure a spacer, roller bearings, and grease within a cup. The seal can also be used to secure the cup assemblies to the trunnions. Typically, the mated components of the U-joint assembly are tightly secured to one another. The cup assemblies may be grease for life structure wherein there is no provision for adding additional grease after assembly.

The U-joint assembly allows for an angular deviation between the axes of rotation of the components. Due to the angular deviation, the velocities of the U-joint components may vary over a single rotation. For example, the angular deviation can cause the U-joint components, such as a yoke, of a driven member, such as a shaft, to speed up and slow down twice in each revolution. The effect of this angular deviation can wear out U-joints and, in particular, the seals and decrease the life span.

Further, when the mated components of the cup assemblies are tightly secured together and to the trunnions, excessive heat can be generated due to the relative movement caused by the angular deviation of the U-joint assembly. This excess heat can lead to the early failure of the U-joint assembly.

On the other hand, if the U-joint assembly is designed with a clearance or gap between the mated components of the cup assemblies and trunnions, the U-joint assembly may become unbalanced. The gap may allow excessive movement of the spider relative to the components which causes an unbalanced assembly and vibration. This vibration can cause excessive wear and premature failure of the U-joint assembly. Thus, it would be advantageous to utilize a U-joint assembly that reduces or minimizes the heat generated while avoiding excessive vibration.

### SUMMARY OF THE INVENTION

The present invention discloses and teaches a U-joint system that advantageously allows for limited relative movement between the cups and the trunnions while avoiding excessive vibration. To achieve this advantage, the U-joint system utilizes a biasing member, exhibiting either or both spring and damping characteristics, that is preloaded to create a desired axial stiffness between the cups and trunnions in the U-joint system. The biasing member allows for limited axial movement between the cups and the trunnions during rotation of the U-joint system. The limited axial movement decreases the heat generated in the U-joint system while avoiding excessive vibration.

In one aspect of the present invention a U-joint system includes a cup, having at least one bearing disposed therein and operable to be disposed on a trunnion. There is a sealing member operable to form a seal between the cup and the trunnion. There is a biasing member that applies an axial static preload of a predetermined magnitude between the cup and the trunnion. The biasing member resists compression and allows for limited relative movement between the cup and the trunnion.

In another aspect of the present invention, a self-aligning U-joint is disclosed. The self-aligning U-joint includes a spider, a pair of yokes, and a plurality of cup assemblies. Each of the cup assemblies has a rigid cup, a sealing member, at least one bearing, and an alignment member. The alignment member is operable to automatically align, to at least a predetermined standard, the cup relative to the trunnion when stationary. The aligning member allows for a limited temporary misalignment between the cup and the trunnion during rotation of the U-joint.

In yet another aspect of the present invention a U-joint system having a cup, at least one bearing, and a sealing assembly is disclosed. In this U-joint system, the sealing assembly includes a first sealing portion, a second sealing portion, and a biasing member. The first sealing portion forms a seal against the cup. The second sealing portion forms a seal against a trunnion upon which the cup is disposed. The biasing member applies an axial static preload of a predetermined magnitude between the cup and the trunnion upon which the cup is disposed. The biasing member resists compression and allows for limited relative movement between the trunnion and the cup.

In still another aspect of the present invention, a method of damping vibration of a U-joint assembly is disclosed. The method includes: (1) axially preloading a cup assembly on a trunnion within the U-joint assembly; (2) compressing a biasing member with the axial preloading; (3) allowing for limited relative movement between the trunnion and the cup assembly during rotation of the U-joint assembly; and (4) damping the relative movement between the trunnion and the cup assembly with the biasing member during rotation of the U-joint assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a shaft having a U-joint system according to the principles of the present invention;

FIG. 2 is an exploded view of the U-joint system of FIG. 1 and the yokes;

FIG. 3 is a flow chart of the assembly of a U-joint according to the principles of the present invention;

FIG. 4A is a partial cross-sectional view of the U-joint system along line 4-4 of FIG. 1 showing a first preferred embodiment of the present invention utilizing a biasing member;

FIGS. 4B and 4C are partial cross-sectional views of the U-joint system along line 4-4 of FIG. 1 showing a first alternate embodiment of the first preferred embodiment of the present invention utilizing a biasing member in a relaxed and compressed state, respectively;

FIGS. 4D and 4E are partial cross-sectional views of the U-joint system along line 4-4 of FIG. 1 showing a second alternate embodiment of the first preferred embodiment of the present invention utilizing a biasing member in a relaxed and compressed state, respectively;

FIG. 4F is a partial cross-sectional view of a portion of the biasing member along line 4F-4F of FIG. 4D;

FIG. 5A is a partial cross-sectional view of the U-joint system along line 4-4 of FIG. 1 showing a second preferred embodiment of the present invention utilizing a biasing belleville washer;

FIG. 5B is a perspective view of the biasing belleville washer of FIG. 5A;

FIG. 6A is a partial cross-sectional view of the U-joint system along line 4-4 of FIG. 1 showing a first alternate embodiment of the second preferred embodiment of the present invention utilizing a biasing finger washer;

FIG. 6B is a perspective view of the biasing finger washer of FIG. 6A;

FIG. 7A is a partial cross-sectional view of the U-joint system along line 4-4 of FIG. 1 showing a second alternate embodiment of the second preferred embodiment of the present invention utilizing a different biasing finger washer;

FIG. 7B is a perspective view of the biasing finger washer of FIG. 7A;

FIG. 8A is a partial cross-sectional view of the U-joint assembly along line 4-4 of FIG. 1 showing a third alternate embodiment of the second preferred embodiment of the present invention utilizing a biasing undulating washer;

FIG. 8B is a perspective view of the biasing undulating washer of FIG. 8A;

FIG. 9A is a partial cross-sectional view of the U-joint assembly along line 4-4 of FIG. 1 showing a fourth alternate embodiment of the second preferred embodiment of the present invention utilizing a friction reducing member in conjunction with a biasing belleville washer;

FIG. 9B is a perspective view of the friction reducing member and biasing belleville washer of FIG. 9A;

FIG. 10 is a partial cross-sectional view of the U-joint system along line 4-4 of FIG. 1 showing a third preferred embodiment of the present invention utilizing a biasing coil spring member;

FIG. 11 is a partial cross-sectional view of the U-joint system along line 4-4 of FIG. 1 showing a first alternate embodiment of the third preferred embodiment of the present invention utilizing a contacting member in conjunction with a biasing coil spring member;

FIG. 12A is a partial cross-sectional view of the U-joint system along line 4-4 of FIG. 1 showing a fourth preferred embodiment of the present invention utilizing a seal having a biasing bridge member;

FIG. 12B is an enlarged cross-sectional view of a portion of the U-joint system within circle 12B of FIG. 12A showing the fourth preferred embodiment of the present invention;

FIG. 13A is an enlarged cross-sectional view of a first alternate embodiment of the fourth preferred embodiment of the present invention utilizing a biasing bridge with a biasing coil spring;

FIG. 13B in an exploded perspective view of the biasing coil spring and inserts of the first alternate embodiment of the fourth preferred embodiment of the present invention shown in FIG. 13A;

FIG. 13C in an exploded perspective view of a biasing radial web spring and inserts used in a second alternate embodiment of the fourth preferred embodiment of the present invention; and

FIG. 13D in an exploded perspective view of a biasing spiral web spring and inserts used in a third alternate embodiment of the fourth preferred embodiment of the present invention.

### DETAILED DESCRIPTION OF THE PREFERRED EMBODIMENTS

The following description of the preferred embodiments is merely exemplary in nature and is in no way intended to limit the invention, its application, or uses.

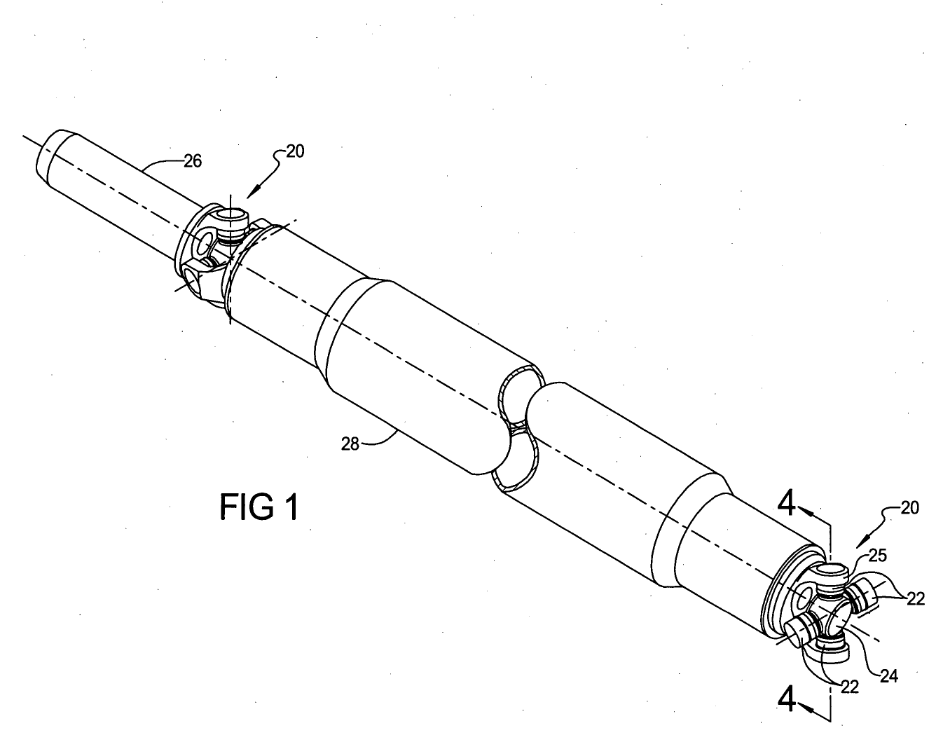

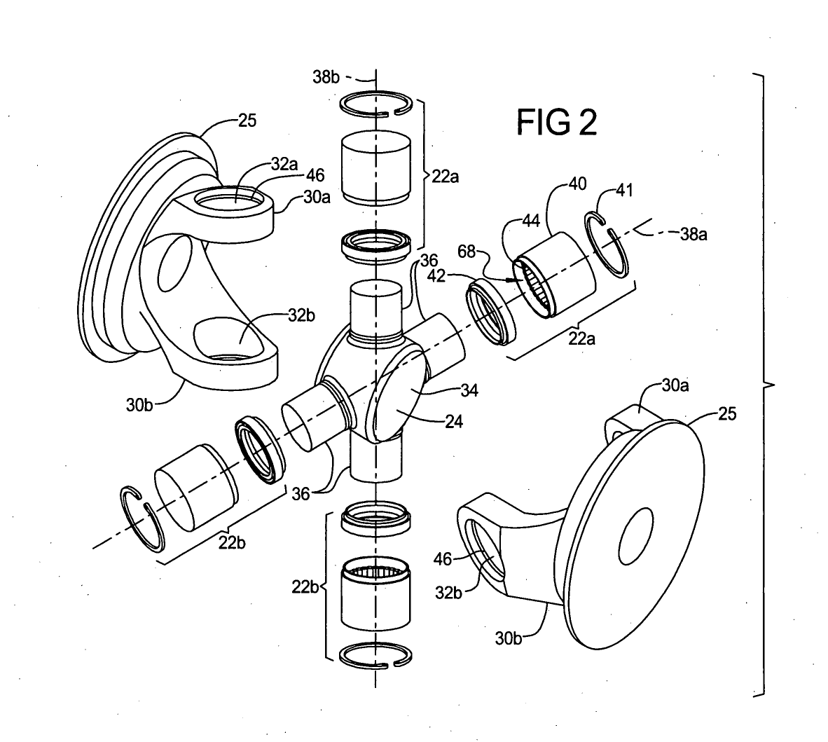

U-joints 20, operable to interconnect two rotatable components 26, 28, such as rotatable shafts, according to the principles of the present invention are shown in FIG. 1. U-joints 20 allow for translating rotation of one component into rotation of the other component. The details of U-joint 20 are shown in FIG. 2. Each U-joint 20 includes four cup assemblies 22 and a spider 24. U-joint 20 is disposed within a pair of yokes 25 that are attached to the ends of components 26, 28. Each yoke 25 includes two arms 30a, 30b with axially aligned openings 32. Yokes 25 on each component 26, 28 are positioned at right angles to each other and are interconnected through spider 24 and cup assemblies 22. Rotation is transferred from one component 26 through its yoke 25, cup assemblies 22, spider 24, and the other yoke 25 to the other component 28. Components 26, 28 can rotate about different axes.

Spider 24 includes a center portion 34 with four cylindrical arms, hereinafter referred to as trunnions 36, extending outwardly from center portion 34. Trunnions 36 are equally spaced apart around center portion 34 at 90 degree intervals and form two pairs of trunnions that are aligned along respective axes 38a, 38b. Each aligned pair of trunnions 36 is disposed within aligned openings 32 of one of the yokes 25 in the final assembly.

As used herein, the terms top/bottom, vertical/horizontal, radial/axial, and other similar terms are used to describe the relative orientations of the various components of the present invention. Accordingly, such terms are relative terms and are based upon the orientation of the components depicted in the detailed drawings. Thus, these terms are not to be construed as absolute terms and need to be interpreted in light of their usage within the preceding and subsequent text and the views depicted in the detailed drawings. Furthermore, axes 38a, 38b are referred to as axial axes and, thus, the terms axial and radial are relative to axes 38a and/or 38b.

Cup assemblies 22 are disposed on each trunnion 36 within one of the openings 32 in yokes 25 in the final assembly. Each cup assembly 22 includes a cylindrical cup 40, a retaining clip 41, and a seal 42. Roller bearings 44 and grease are disposed within each cup 40. Bearings 44 and the grease allow for relative rotational movement between trunnion 36 and cup 40. Relative movement between cup 40 and trunnion 36 results from angular deviation between the axes of rotation of components 26, 28. Cup 40 oscillates back and forth during rotation due to the angular deviation between the linked components. For example, when the angular deviation is about 6°, cup 40 may oscillate back and forth about ±6° relative to trunnion 36.

Seal 42 secures cup 40 to trunnion 36. Seal 42 engages a wall of cup 40 and trunnion 36 and forms a shield around bearings 44 that keeps grease within and contamination out of cup 40 when secured to trunnion 36. Retaining clip 41 is C-shaped and locks cup assembly 22, when secured to trunnion 36, within openings 32 of yokes 25. Specifically, clip 41 locks into an annular recess 46 in each yoke arm 30a, 30b and engages with the bottom surface of cup 40 to thereby lock cup assembly 22 within yoke 25.

According to the principles of the present invention, resilient biasing members are used in the U-joints. The biasing members can have both spring and damping characteristics. The biasing members have a spring rate of a predetermined value and may damp relative movement (axial and/or rotational) between cup 40 and trunnion 36 over a predetermined frequency range during rotation of the U-joint system. The spring rate can be a constant spring rate or a progressive spring rate that changes with compression of the biasing member. The biasing members may be disposed between cups 40 and trunnions 36 or located in other positions on U-joint 20, as described below. The biasing members are statically preloaded/compressed and exert a biasing force to create an axial stiffness between cups 40 and trunnions 36, but allow for limited relative movement between cups 40 and trunnions 36 during rotation of U-Joint 20. During rotation of U-joint 20, the amount of compression of the biasing members will vary. The biasing members and cup assemblies 22 are dimensioned to maintain the biasing members in a compressed state during operation. As a result, the biasing members continue to exert a biasing force and prevent excessive vibration of U-joint 20 during rotation while maintaining a desired loading on the components of U-joint 20. Additionally, the biasing members may damp the vibrations that occur during rotation.

Biasing members of a variety of configurations can be utilized, as described below with reference to the preferred embodiments and alternates thereto. Some biasing members may have characteristics that allow for self-alignment as rotation of U-joint 20 decreases and/or ceases. The self-aligning feature allows for a limited temporary misalignment between cup 40 and trunnion 36 during rotation of U-joint 20, as described below.

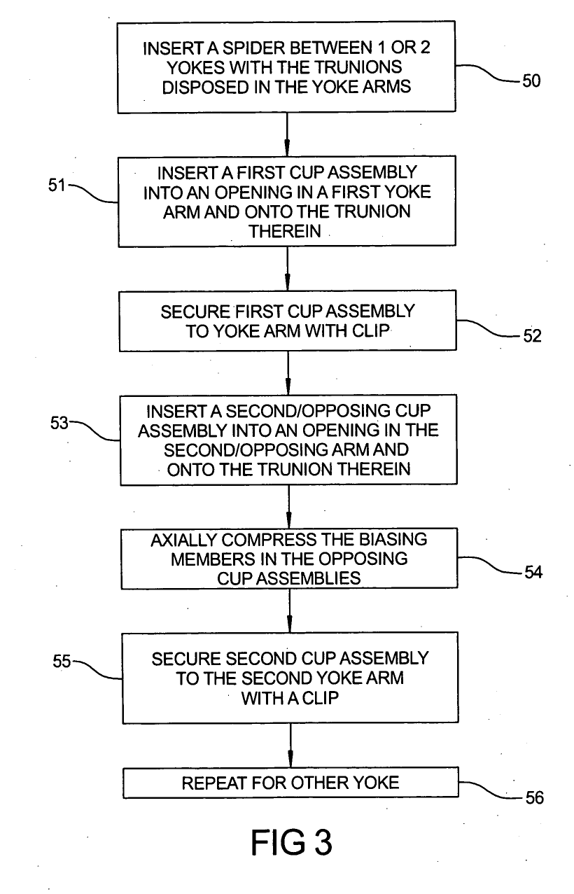

The assembly of a U-joint 20 including the biasing members according to the principles of the present invention is shown in FIG. 3. U-joint 20 is generally formed by securing four cup assemblies 22 to the four trunnions 36 of a spider 24 within yokes 25. Each cup assembly includes one of the biasing members discussed below. The biasing members are disposed between the cup assemblies 22 and the trunnions 36 in such a way as to impart a biasing force and axially preload the cups relative to the trunnions.

To begin, a spider 24 is inserted between one or two yokes 25 with trunnions 36 disposed in the yoke arms 30a, 30b, as indicated in block 50. A first cup assembly 22a is inserted into one opening 32a of one yoke arm 30a and onto the trunnion 36 therein, as indicated in block 51. First cup assembly 22a is secured to yoke arm 30a with clip 41, as indicated in block 52. A second/opposing cup assembly 22b is inserted into the other opening 32b of the other yoke arm 30b and onto the trunnion 36 therein, as indicated in block 53. Second cup assembly 22b is pushed onto its associated trunnion 36 to cause the biasing members in the opposing cup assemblies 22a, 22b to be axially compressed, as indicated in block 54. Second cup assembly 22b is then secured to the second yoke arm 30b with a clip 41, as indicated in block 55. The opposing cup assemblies are thereby secured within the yoke 25 with the biasing members axially compressed. The bias members exert a biasing force between the cup assemblies and the trunnion and thereby impart an axial preload. The process is repeated for the other yoke 25 that forms U-joint 20, as indicated in block 56. The other yoke will be inserted on spider 24 with the trunnions disposed in the openings in the associated yoke arms, if this was not performed above in block 50. Thus, a U-joint 20 so assembled has two opposing pairs of cup assemblies 22 that are axially preloaded, relative to the trunnions 36 disposed therein, by the biasing members of each cup assembly 22.

A number of factors contribute to the magnitude of the axial preloading that can be imparted between the opposing cup assemblies and the trunnion. The engagement between seal 42 and trunnion 36 limits the degree to which seal 42, and its associated cup assembly 22, can be positioned onto the associated trunnion 36. The distance between recesses 46 in opposing yoke arms 30a, 30b and the interaction between clips 41 and the bottom surfaces of cups 40 define the maximum distance between the ends of opposing cups 40. Additionally, the configuration, dimensions, geometry and materials from which the biasing members are made also affect the axial preloading that will occur between the opposing cup assemblies and the associated trunnion.

During rotation of U-joint 20, the resilient biasing members allow for limited relative axial movement between cup assemblies 22 and the associated trunnions 36. As U-joint 20 rotates, each resilient biasing member maintains contact between cup assembly 22 and trunnion 36 and imparts a biasing force in relation to the compression of the biasing member at that particular time. The biasing member is designed to maintain a compressive force within a predetermined range during nominal operation of U-joint 20. The predetermined magnitude of the biasing force will vary depending upon the design of U-joint 20 and the operational needs of U-joint 20. Additionally, the biasing member may also provide damping characteristics that damp the relative movement between cup assembly 22 and the trunnion 36 thereby further avoiding excessive or undesirable vibration of U-joint 20 during rotation.

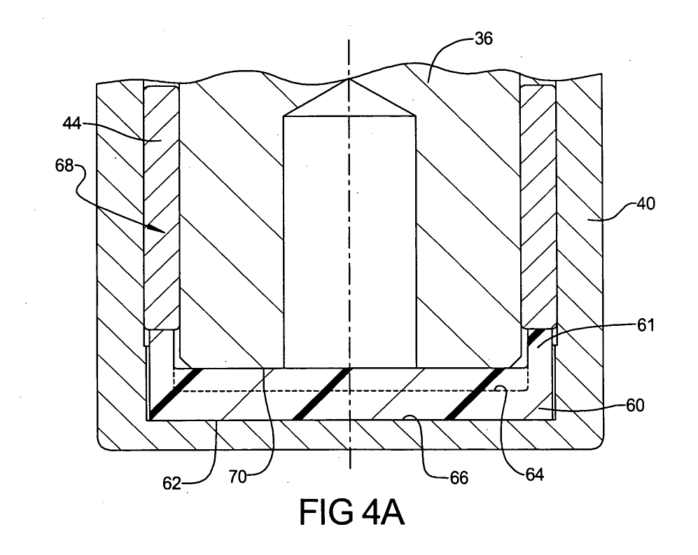

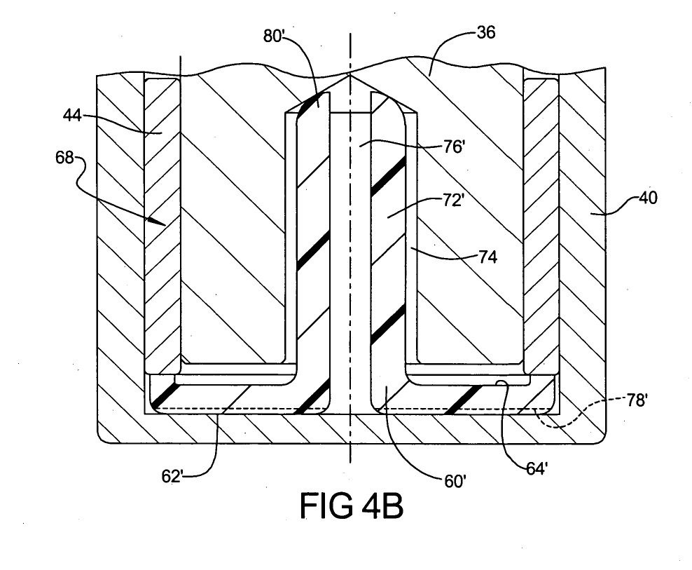

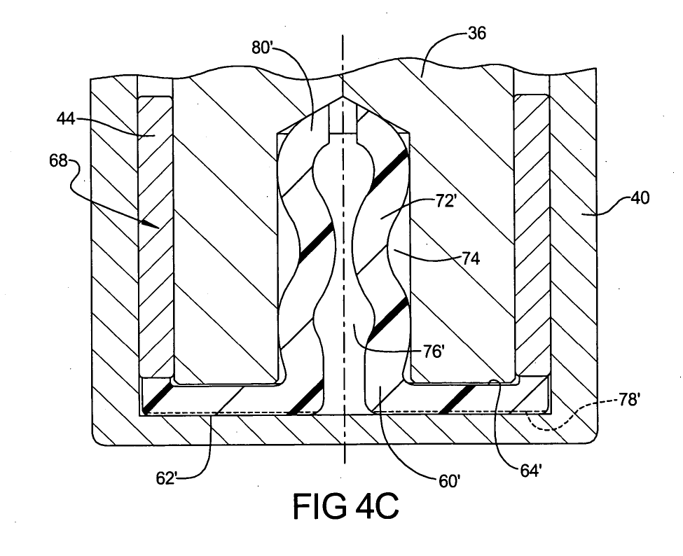

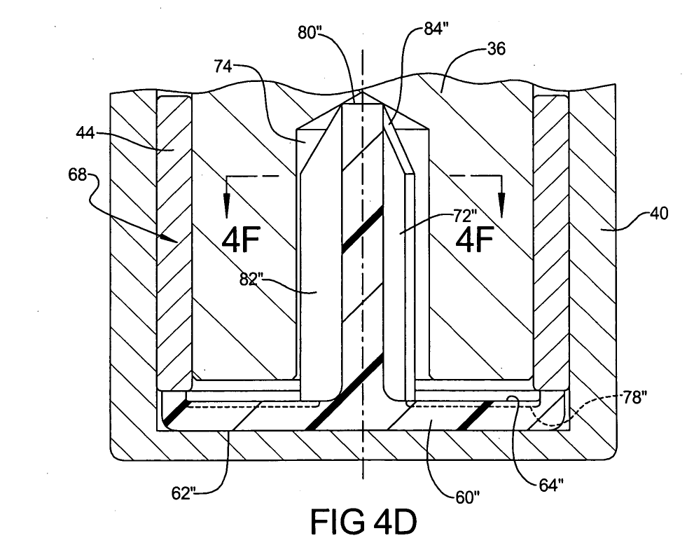

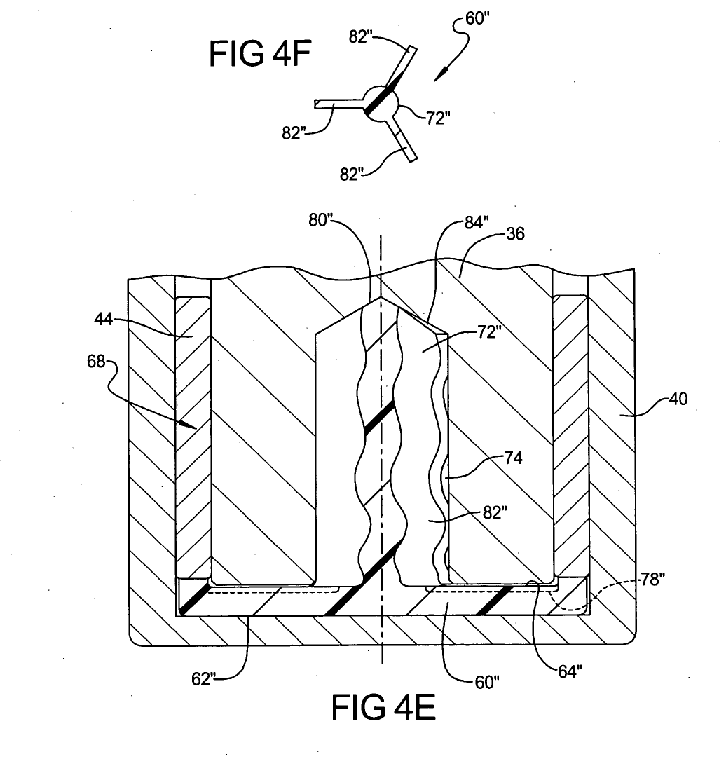

The biasing members that can be utilized in a U-joint 20 according to the principles of the present invention can take a variety of configurations, as stated above. A first preferred embodiment of the U-joint utilizing a biasing member is shown in FIG. 4A. A resilient biasing member 60 (shown in a relaxed or uncompressed state in solid lines and in a compressed state in phantom) is disposed within cup 40. Resilient biasing member 60 is preferably circular or annular although other geometries can be used. Resilient biasing member 60 includes a lip 61 that extends upwardly from the outer edge of resilient biasing member 60. Lip 61 limits the axial movement of bearings 44 during rotation of U-joint 20. Biasing member 60, as shown in phantom, is compressed by trunnion 36, as discussed below. Preferably, resilient biasing member 60 is made of natural rubber or elastomeric material such as, rubber, urethane, foamed rubber and foamed urethane. Resilient biasing member 60 may be made of a single material, or alternatively, from multiple materials. For example, lip 61 can be made of a first material while the main body is made from a second material, such as a stiffer or less stiff material. The main body of resilient biasing member 60 has a bottom surface 62 and a top surface 64, both extending radially in relation to axial axis 38b. Bottom surface 62 is flush against a bottom surface 66 of a cavity 68 in cup 40. Top surface 64 is compressed by an end surface 70 of trunnion 36 when cup assemblies 22 are preloaded onto trunnions 36, as indicated in phantom. Resilient biasing member 60 has a plurality of radially-extending channels (not shown) to allow grease to move around within cavity 68 of cup 40.

Referring now to FIGS. 4B and 4C, a first alternate embodiment of the first preferred embodiment is shown with the resilient biasing member 60′ in a relaxed/non-compressed state and a compressed state, respectively. In this first alternate embodiment, resilient biasing member 60′ has an axially extending portion 72′ that extends upwardly from top surface 64′ and into reservoir 74 of trunnion 36. Axially extending portion 72′ has a central channel 76′ that extends axially through an entirety of axial portion 72′ and through the main body of resilient biasing member 60′. A plurality of radially extending channel 78′ extend from axial channel 76′ along bottom surface 62′ of resilient biasing member 60′. Axial channel 76′ is filled with grease and radial channels 78′ allow the grease therein to flow throughout cavity 68. The flow of the grease is promoted by relative movement between biasing member 60′, trunnion 36 and cup 40. Optionally, a plurality of radially-extending channels or holes (not shown) can be provided in axially extending portion 72′ to further facilitate grease movement throughout reservoir 74 and cavity 68. Axially extending portion 72′ is compressed, as shown in FIG. 4C, by the top of reservoir 74 of trunnion 36 when the cup assemblies are preloaded onto trunnions 36.

Referring now to FIGS. 4D, 4E and 4F, a second alternate embodiment of the first preferred embodiment is shown. In this embodiment, resilient biasing member 60″ includes an axially extending portion 72″ that extends upwardly within reservoir 74 of trunnion 36. Axially extending portion 72″ includes a plurality of fins 82″ that extend radially outwardly from axially extending portion 72″ and extend axially along the entire length of axially extending portion 72″. A top portion 84″ of fins 82″ tapers radially inwardly toward the top 80″ of axially extending portion 72″. Tapering portions 84″ and top 80″ of axially extending portions 72″ are compressed by the top of reservoir 74 of trunnion 36 when cup assemblies 22 are preloaded onto trunnions 36, as shown in FIG. 4E. Resilient biasing member 60″ includes a plurality of radially extending channels 78″ that extend along top surface 64″. Grease is packed within reservoir 74 and radially extending channels 78″ facilitate the movement of the grease throughout cavity 68 due to relative movement between trunnion 36, resilient biasing member 60″ and cup 40.

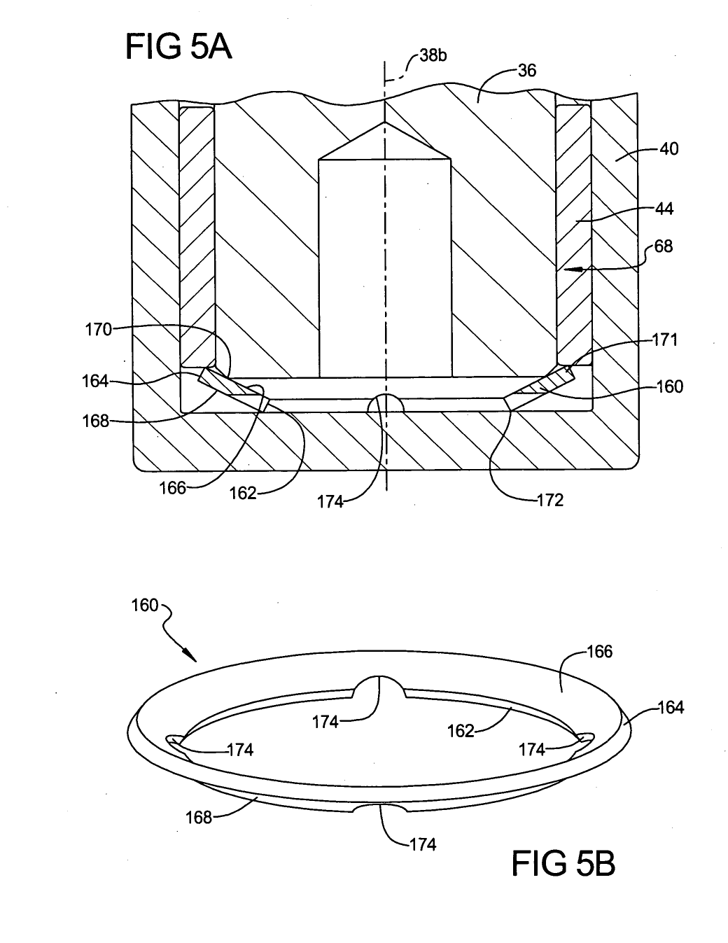

Second preferred embodiments of the present invention are shown in FIGS. 5A-9B. In the second preferred embodiments, the biasing members are in the form of resilient spring washers. Spring washer of differing geometries are preloaded between cups 40 and trunnions 36 in U-joint 20, as described in more detail below. The spring washers can be made from a variety of materials, such as metal, nylon, engineered polymers, or other similar materials.

FIGS. 5A and 5B show the second preferred embodiment wherein a biasing belleville washer 160 is disposed between cup 40 and trunnion 36. Belleville washer 160 is axially preloaded/compressed between cup 40 and trunnion 36 and allows limited axial movement between cup 40 and trunnion 36 during rotation. Belleville washer 160 includes a radially inner surface 162 and a radially outer surface 164. Belleville washer 160 further includes an upper surface 166 that extends between the upper portions of surfaces 162 and 164 and a lower surface 168 that extends between the lower portions of surfaces 162 and 164. Both upper surface 166 and lower surface 168 extend axially upwardly as they extend radially outwardly. Upper surface 166 engages a radially outer portion of trunnion 36 at region 170. Region 170 extends 360° around upper surface 166. A portion 171 of belleville washer 160 extends radially beyond trunnion 36 and limits the axial movement of bearings 44. Region 172 of lower surface 168 engages bottom surface 66 of cup 40. Region 172 extends 360° around lower surface 168. Region 172 is radially inward of region 170. Belleville washer 160 also includes a plurality of radially extending openings or channels 174 that allow grease to move around within cavity 68 of cup 40. The limited contact area between belleville washer 160 and trunnion 36 limits the heat generated during rotation.

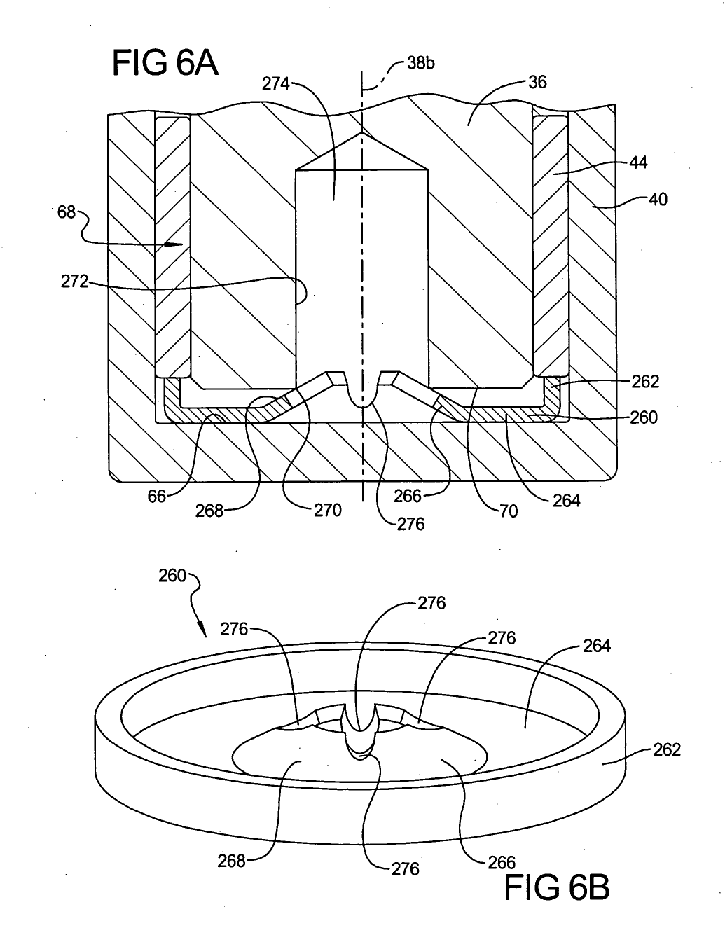

In a first alternate embodiment to the second preferred embodiment, the resilient spring washer is a biasing finger washer 260 as shown in FIGS. 6A and 6B. Finger washer 260 is axially preloaded/compressed between cup 40 and trunnion 36 and allows for limited axial movement between cup 40 and trunnion 36 during rotation. Finger washer 260 is annular and has an axially extending vertical portion 262, a radially extending horizontal portion 264, and an axially and radially extending diagonal portion 266. Vertical portion 262 is the radially outermost portion of finger washer 260 and limits the axial movement of bearings 44. Horizontal portion 264 extends radially inwardly from vertical portion 262 and sits flush against bottom surface 66 of cavity 68 in cup 40. Diagonal portion 266 extends from the radially innermost portion of horizontal portion 264. An upper surface 268 of diagonal portion 266 engages with region 270 of trunnion 36. Region 270 corresponds to a junction of end surface 70 of trunnion 36 and an axial wall 272 of a trunnion reservoir 274. Region 270 extends 360° around outer surface 268. Finger washer 260 also includes a plurality of radially-extending channels 276 to allow grease to move around within cavity 68 of cup 40.

This configuration can further reduce the heat generated during rotation due to the proximity of region 270 to axial axis 38b. Relative movement between cup 40 and trunnion 36 increases at positions radially away from the center of rotation along axial axis 38b. Region 270 corresponds to an area of lesser relative movement based on the position relative to the center of rotation along axial axis 38b. Thus, the heat generated by the relative movement between cup 40 and trunnion 36 can be decreased with this configuration.

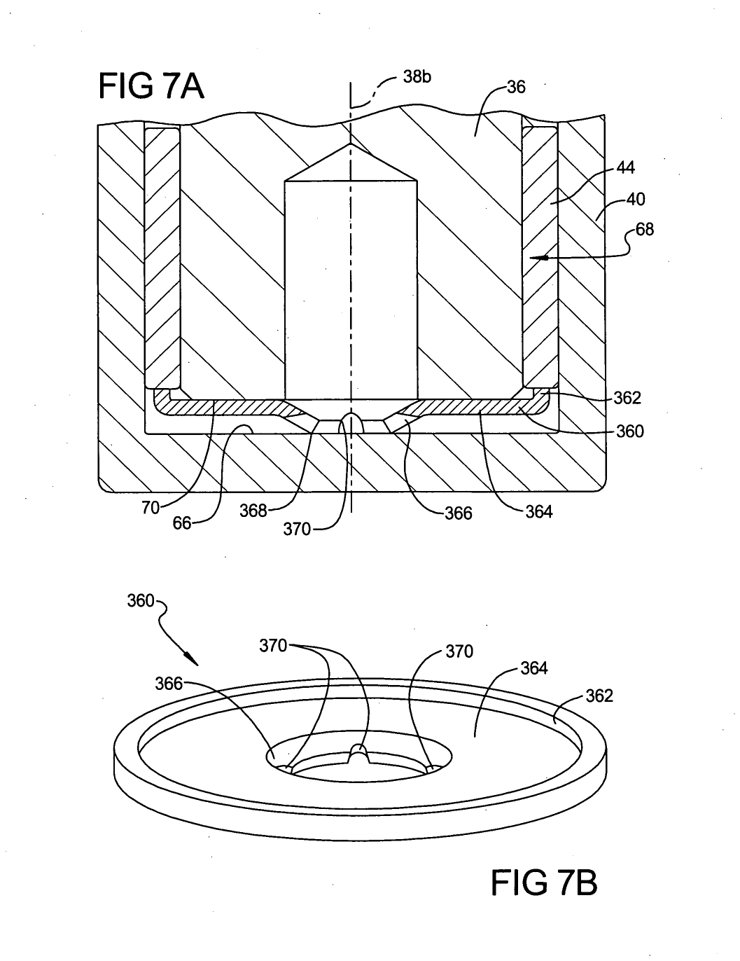

Referring now to FIGS. 7A and 7B, a second alternate embodiment of the second preferred embodiment is shown. In this second alternate embodiment, a biasing finger washer 360 having a different configuration is utilized. Finger washer 360 is axially preloaded/compressed between cup 40 and trunnion 36 and allows limited axial movement between cup 40 and trunnion 36 during rotation. Finger washer 360 is annular and has an axially extending vertical portion 362, a radially extending horizontal portion 364, and an axially and radially extending diagonal portion 366. Vertical portion 362 forms the radially outermost portion of finger washer 360 and limits the axial movement of bearings 44. Horizontal portion 364 extends radially inwardly from vertical portion 362 and sits flush against end surface 70 of trunnion 36. Diagonal portion 366 extends from the radially innermost portion of horizontal portion 364 and contacts bottom surface 66 of cavity 68 in cup 40 at region 368. Region 368 extends 360° and results in a limited amount of contact between cup 40 and finger washer 360. The proximity of region 368 to axial axis 38b reduces the heat generated by the relative movement between cup 40 and trunnion 36. Finger washer 360 also includes a plurality of radially-extending openings/channels 370 to allow grease to move around within cavity 68 of cup 40.

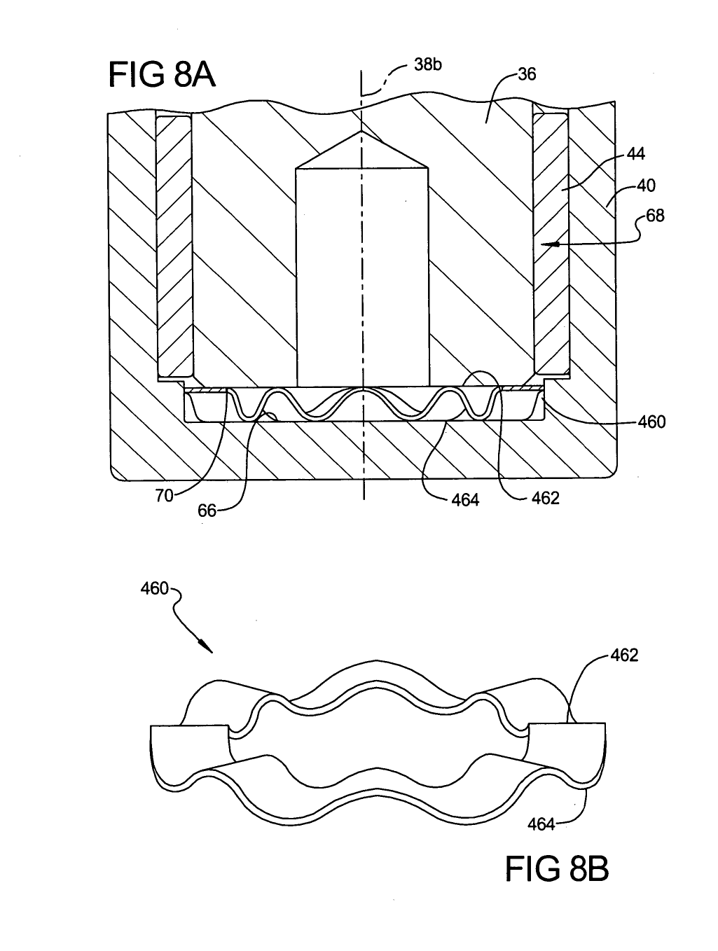

In a third alternate embodiment of the second preferred embodiment, the resilient spring washer is a biasing undulating or wavy washer 460 and is disposed between trunnion 36 and cup 40 as shown in FIGS. 8A and 8B. Undulating washer 460 is axially preloaded/compressed between cup 40 and trunnion 36 and allows limited axial movement between cup 40 and trunnion 36 during rotation. Undulating washer 460 has a series of high surfaces 462 and low surfaces 464 that alternate as undulating washer 460 extends 360°. High surfaces 462 engage with end surface 70 of trunnion 36 while low surfaces 464 engage with bottom surface 66 of cavity 68 in cup 40.

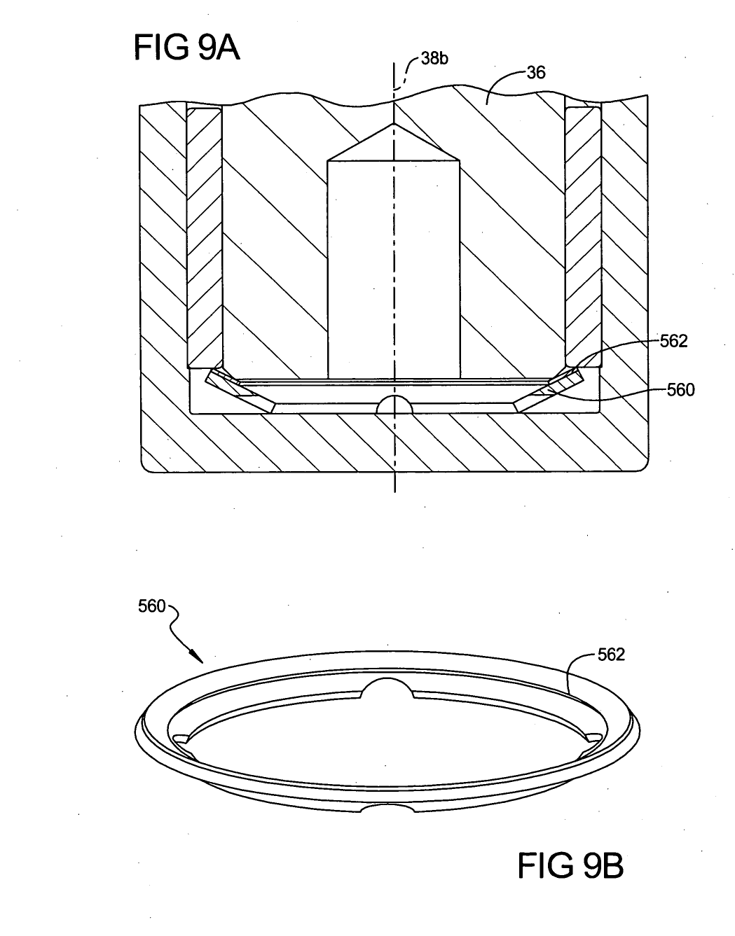

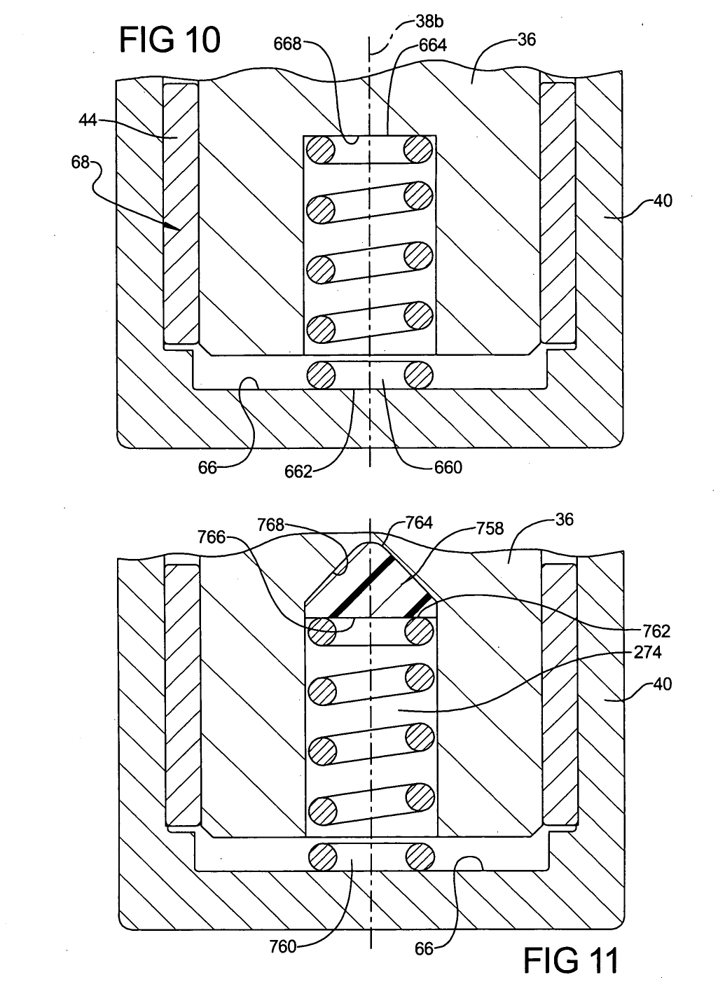

A modification to the belleville washer is shown in FIGS. 9A and 9B. Specifically, biasing belleville washer 560 includes a friction-reducing member or layer 562. Layer 562 is disposed between belleville washer 560 and trunnion 36 and decreases the friction between trunnion 36 and belleville washer 560 and, thus, further reduces the heat generated between the two components. Layer 562 may be a PTFE material or another material known to reduce friction. It should be appreciated that friction reducing layer 562 can be utilized on or in conjunction with the other embodiments discussed previously or subsequently herein to reduce friction and heat generation.

Referring now to FIG. 10, a third preferred embodiment of the present invention is shown wherein the biasing member is a biasing coil spring 660. Coil spring 660 is axially preloaded/compressed between cup 40 and trunnion 36 and allows limited axial movement between cup 40 and trunnion 36 during rotation. Coil spring 660 has a flat bottom 662 and a flat top 664. Bottom 662 engages bottom surface 66 of cavity 68 in cup 40 while top 664 engages an end surface 668 of the trunnion reservoir. End surface 668 is a radially flat surface. It should be appreciated, however, that end surface 668 does not need to be flat so long as top 664 can engage with end surface 668. The proximity of the engaging portions of coil spring 660 relative to axial axis 38b reduces the heat generated during rotation. It should be noted that different spring configurations can be used.

An alternate embodiment of the third preferred embodiment utilizing a contacting member 758 in addition to a coil spring 760, is shown in FIG. 11. Contacting member 758 is disposed between a top end 762 of coil spring 760 and end surface 668 of trunnion reservoir 274. Coil spring 760 with contacting member 758 disposed thereon are axially preloaded/compressed between cup 40 and trunnion 36 and allow limited axial movement between cup 40 and trunnion 36 during rotation. Contacting member 758 has a top portion 764 configured to engage with an end surface 768 of trunnion 36. Preferably, top portion 764 and end surface 768 are complementary to one another. For example, top portion 764 can be convex shaped, such as spherical or conical with a rounded tip, while end surface 768 is concave shaped. A bottom portion 766 of contacting member 758 is configured to engage with top end 762 of coil spring 760. For example, bottom portion 766 can be flat (as shown) and rest on flat top 762 of coil spring 760 or can have a projection (not shown) that extends into the center of coil spring 760 and, if desired, all the way to bottom surface 66 of cup 40. Preferably, contacting member 758 and coil spring 760 are centered on axial axis 38b. This configuration provides a self-aligning feature wherein coil spring 760 and contacting member 758 bias cup 40 and trunnion 36 to an axially aligned position. It is believed that the self-aligning feature will be greatest when U-joint 20 is not rotating.

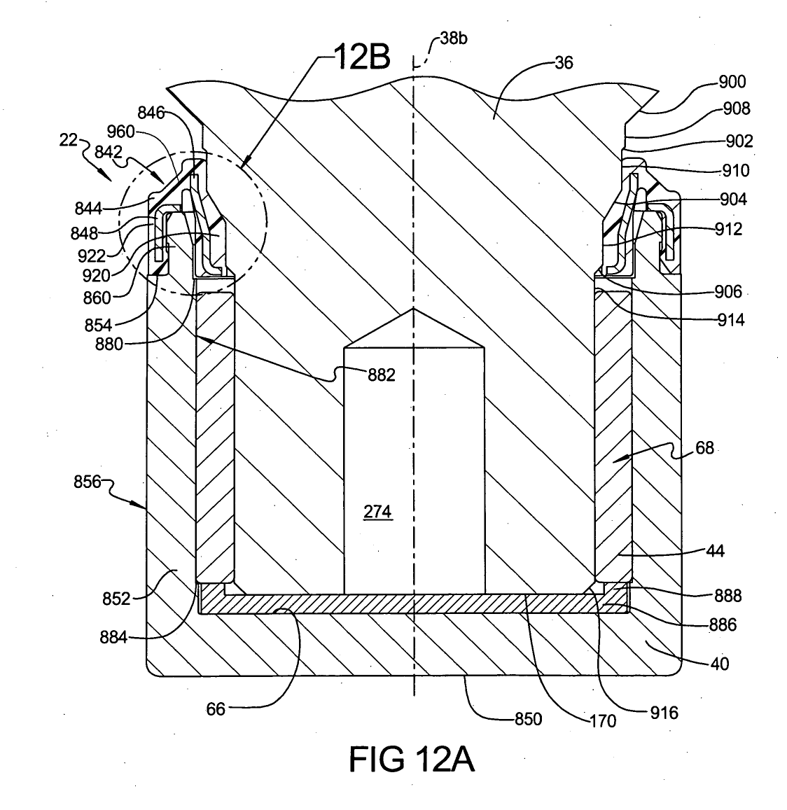

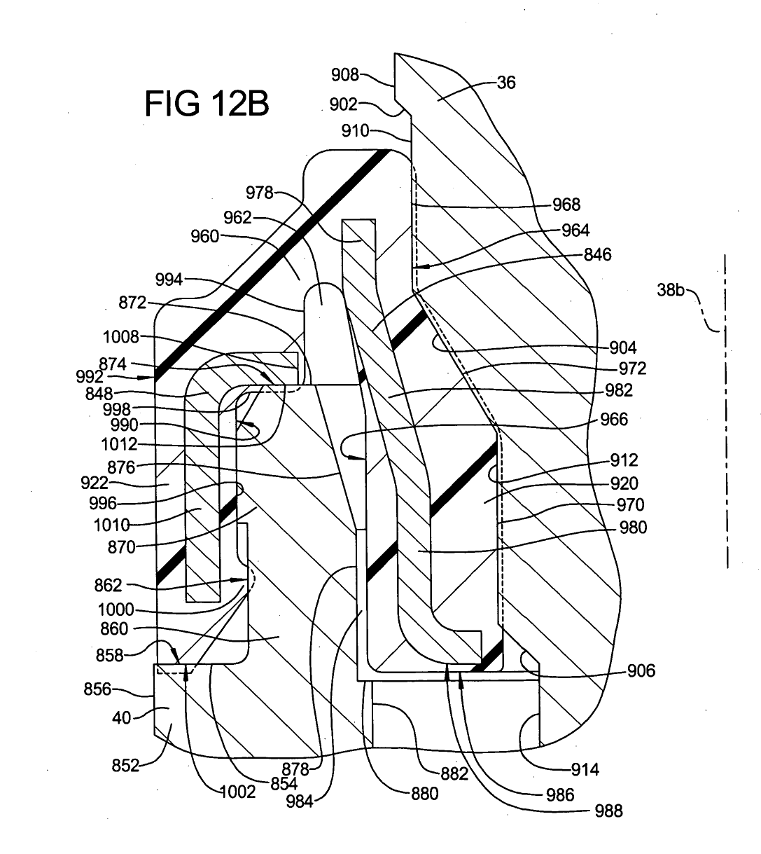

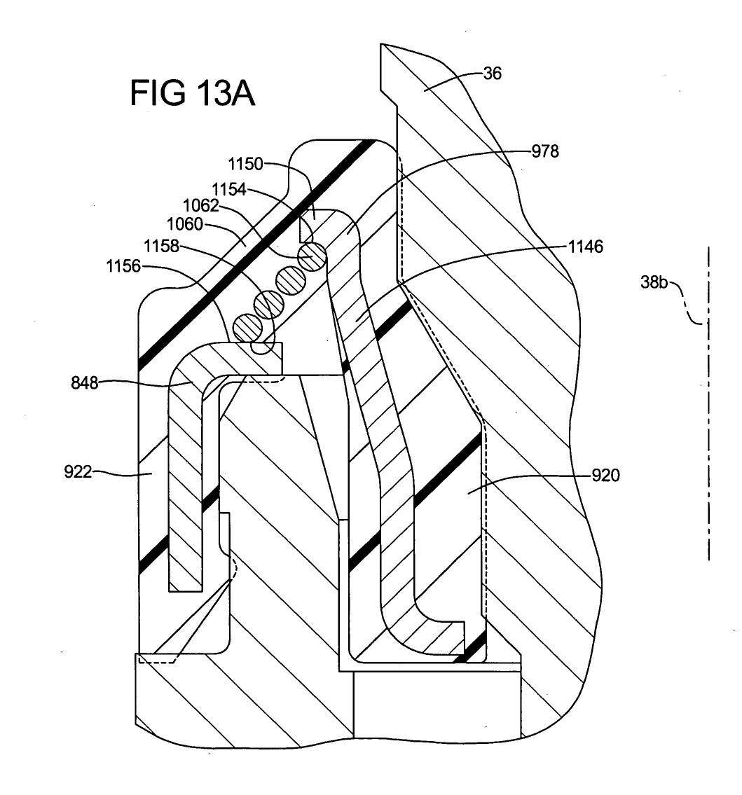

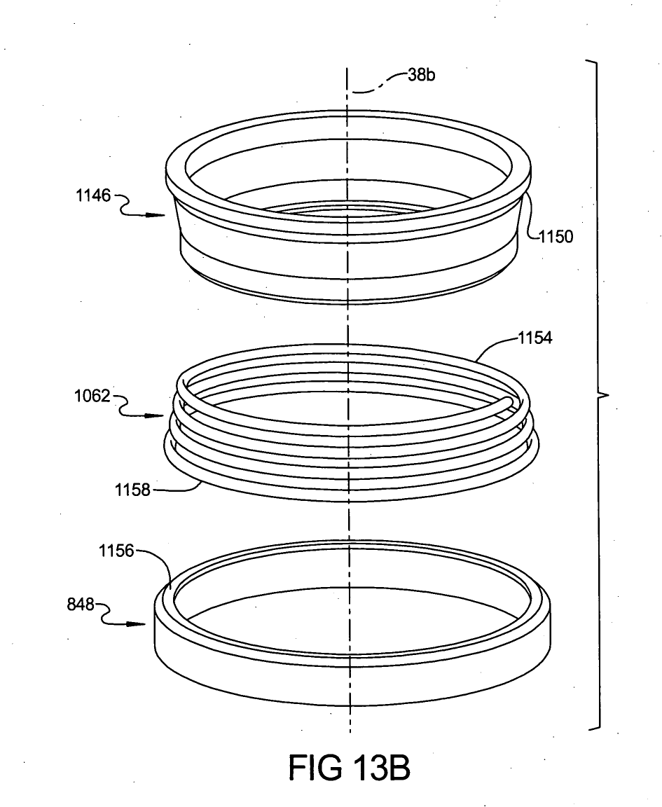

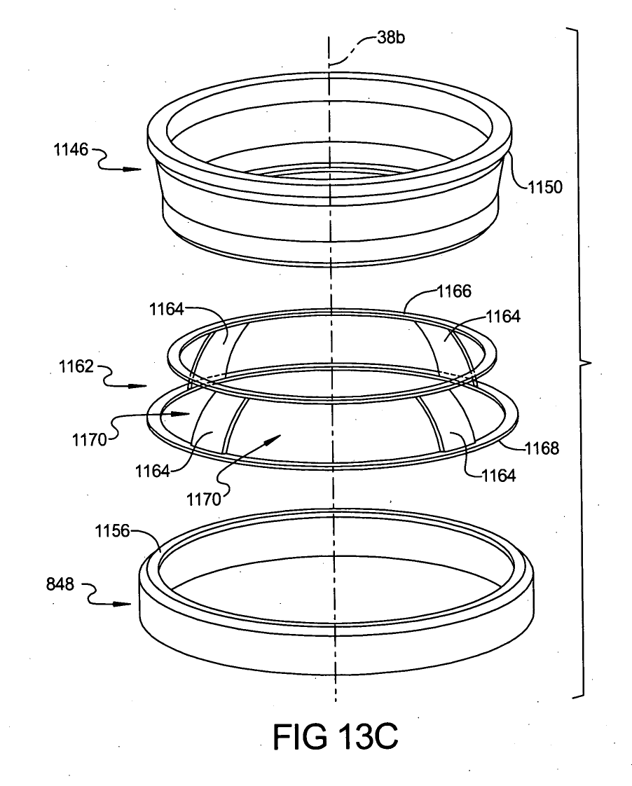

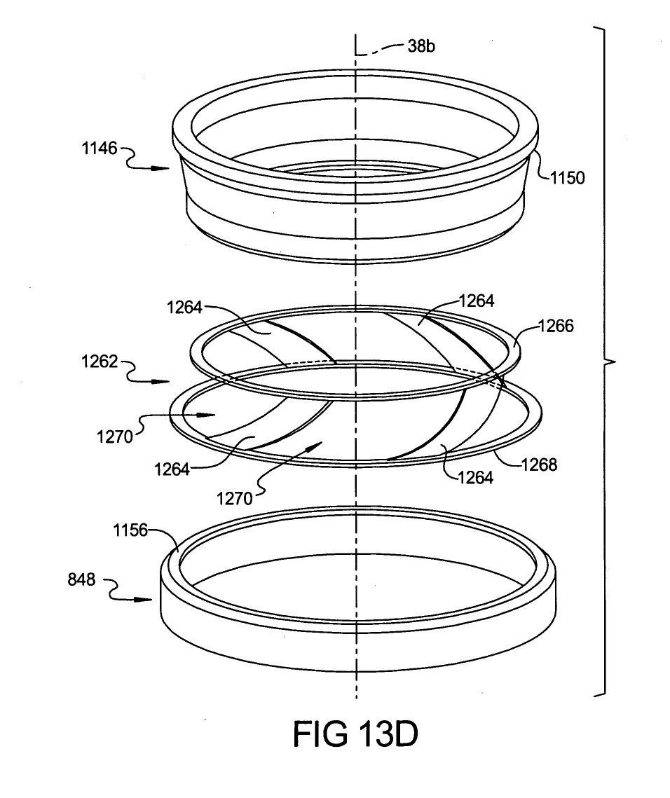

A fourth preferred embodiment of the present invention and alternate embodiments thereof are shown in FIGS. 12A-13D. In these embodiments, the biasing function is performed by the seal between cup 40 and trunnion 36. The seal, as described below, includes a component (biasing member) that performs the biasing and damping functions. The biasing member of the seal is axially preloaded/compressed between cup 40 and trunnion 36 and allows limited axial movement between cup 40 and trunnion 36 during rotation.

Referring to FIGS. 12A and 12B, a seal 842 according to the fourth preferred embodiment of the present invention is shown. Each seal 842 includes an annular resiliently compressible retaining member 844 and two rigid annular inserts 846, 848 disposed therein. Retaining member 844 can be made of a variety of materials. Such materials include, but are not limited to, AEM, NBR, XNBR, HNBR, ACM, and FKM. The rigid inserts can be made from a variety of materials. Such materials include, but are not limited to, 1050 stamped steel, 1008 steel, 1010 steel, nylon 66, brass, high temperature plastics, and powdered metals.

Cup 40 has a flat bottom 850 with a generally cylindrical sidewall 852 extending therefrom and defining cavity 68. An outer shoulder 854 in an outer surface 856 extends radially inwardly and forms a first sealing surface 858 between cup 40 and seal 842, as described in more detail below. The outer surface of an upper extension 860 of sidewall 852 forms a second sealing surface 862 between cup 40 and seal 842, as described in more detail below. A pawl 870 extends radially outwardly from the outer surface of extension 860. A top edge 872 of extension 860 forms a third sealing surface 874 between cup 40 and seal 842, as described in more detail below. The inner surface of extension 860 includes a tapering portion 876 and a vertical portion 878. A shoulder 880 is formed on an inner surface 882 of sidewall 852 adjacent vertical portion 878 of extension 860. Another shoulder 884 is located on inner surface 882 adjacent bottom surface 66 of cavity 68.

A spacer 886 is disposed within cavity 68 of cup 40 on bottom surface 66. Spacer 886 is preferably either circular or annular although other shapes can be used. Spacer 886 includes a lip 888 that extends upwardly from the outer edge of spacer 886. Typically, when assembled, spacer 886 is flush against both bottom surface 66 of cavity 68 and against end surface 70 of trunnion 36. Spacer 886 thereby forms a tight joint between trunnion 36 and bottom surface 66 of cup 40. It should be appreciated that a gap (not shown) could exist between spacer 886 and bottom surface 66 or end surface 70 of trunnion 36. This gap would allow for relative movement between cup 40 and trunnion 36 that would be controlled by seal 842 as described below. Spacer 886 has a plurality of radially-extending channels (not shown) to allow grease to move around within cavity 68 of cup 40. Shoulder 884 limits radial movement of spacer 886.

Bearings 44 are disposed within cavity 68 of cup 40 and may reside on lip 888 of spacer 886 and/or shoulder 884. Bearings 44 contact both trunnion 36 and cup 40. Bearings 44 facilitate relative movement between cup 40 and trunnion 36. Bearings 44 are typically a plurality of roller bearings, but may include other types of bearings know in the art.

Seal 842 completes cup assembly 22 and, when pressed onto cup 40, forms a mechanical loading and seals against sealing surfaces 858, 862, 874, as described in more detail below. Seal 842 can be manually placed on cup 40 without the use of machinery.

Cup assembly 22 is disposed on the outer periphery or surface of trunnion 36. Trunnion 36 is generally cylindrical. The outer surface of trunnion 36 includes four radially tapering sections 900, 902, 904, 906 and four axially extending straight sections 908, 910, 912, 914. The outer surface of trunnion 36 also includes a chamfer 916 adjacent to end surface 70 of trunnion 36. Reservoir 274 is disposed in end surface 70 of trunnion 36. Reservoir 274 acts as a storage for grease. The contour of the outer surface of trunnion 36 allows for a relatively high mechanical loading to be imparted between trunnion 36 and seal 842, as described in more detail below.

Retaining member 844 has radially spaced apart first and second annular legs 920, 922 interconnected by a flexible bridge 960 that acts as the resilient biasing member in this embodiment, as described in more detail below. An annular cavity 962 exists between legs 920, 922. First leg 920 is disposed radially inwardly from second leg 922. First and second legs 920, 922 each have multiple compressible sealing surfaces that respectively engage with the outer surface of trunnion 36 and with cup 40. First annular insert 846 is disposed within first leg 920 while second annular insert 848 is disposed within second leg 922. First and second inserts 846, 848 limit radial movement of portions of first and second legs 920, 922. First and second legs 920, 922 in conjunction with inserts 846, 848 impart sealing forces in a radially inward direction and of differing magnitudes. That is, first and second legs 920, 922 allow for two separate loads to be applied by seal 842. Legs 920, 922 also impart an axial sealing force(s). First leg 920 in conjunction with first insert 846 forms a static seal against trunnion 36 while second leg 922 in conjunction with insert 848 forms a dynamic seal against cup 40 which may move or oscillate relative to seal 842 during rotation of components 26, 28. This sealing arrangement retains grease within and keeps contaminates out of cavity 68 of cup 40.

First leg 920 has radially opposite inner and outer surfaces 964, 966. Inner surface 964 has two straight sections 968, 970 (generally parallel with axial axis 38b) and a radially tapering section 972 therebetween. Similarly, first insert 846 has a pair of straight sections 978, 980 (generally parallel with axial axis 38b) and a radially tapering section 982 therebetween. Straight sections 978, 980 and tapering sections 982 of first insert 846 are respectively generally aligned with straight sections 968, 970 and tapering section 972 of inner surface 964 of first leg 920. First leg 920 and first insert 846 are dimensioned to cause inner surface 964 of first leg 920 to compress and deform against the outer surface of trunnion 36. First leg 920 and first insert 846 form a static seal against trunnion 36 with first insert 846 limiting radially outward deformation of first leg 920. Specifically, straight sections 968, 970 respectively engage, compress, and seal against straight sections 910, 912 of trunnion 36 while tapering section 972 engages, compresses, and seals against tapering section 904 of trunnion 36. The uncompressed dimensions of inner surface 964 of first leg 920 are represented in phantom on trunnion 36 in FIG. 12B. The contour of inner surface 964 of first leg 920 and that of first insert 846 limits the axial position of seal 842 on trunnion 36. Outer surface 966 of first leg 920 is dimensioned and contoured to provide a gap 984 between outer surface 966 and the inner surface of extension 860 of cup 40. A bottom surface 986 of first leg 920 in conjunction with a bottom section 988 of first insert 846 limit axial movement of bearings 44 within cup 40.

Second leg 922 has radially opposite inner and outer surfaces 990, 992. Inner surface 990 has two straight sections 994, 996 (generally parallel with axial axis 38b) with a radially extending flat section 998 therebetween. A bump or projection 1000 extends radially inwardly from the lower portion of inner surface 990. A radially flat bottom surface 1002 of second leg 922 extends between inner and outer surfaces 990, 992. Similarly, second insert 848 has a pair of straight sections 1008, 1010 (generally parallel to axial axis 38b) and a radially extending flat section 1012 therebetween. Straight sections 1008, 1010 and flat section 1012 of second insert 848 are respectively generally aligned with straight sections 994, 996 and flat section 998 of inner surface 990 of second leg 922. Second leg 922 and second insert 848 are dimensioned to cause the inner and bottom surfaces 990, 1002 of second leg 922 to compress and deform against cup 40 and form a dynamic seal therebetween with second insert 848 limiting radially outward and axially upward deformation of second leg 922. Specifically, second leg 922 and second insert 848 are configured to cause radially flat sections 998, 1002 and projection 1000 to respectively engage, compress, and seal against top edge 872 of extension 860 at third sealing surface 874, outer shoulder 854 of cup sidewall 852 at first sealing surface 858, and on the outer surface of extension 860 at second sealing surface 862. The uncompressed dimensions of radially flat sections 998, 1002 and projection 1000 are represented by the phantom lines in FIG. 12B imposed on cup 40.

The contours and dimensions of first and second legs 920, 922 and that of first and second inserts 846, 848 are designed to provide a static seal against trunnion 36 and a dynamic seal against cup 40. To achieve this, the contours and dimensions are set so that the mechanical loading that occurs between first leg 920 and trunnion 36 is greater than the mechanical loading that occurs between second leg 922 and cup 40.

Compressible bridge 960 allows for relative movement between first leg 920 and second leg 922 during rotation of components 26, 28. Bridge 960 is flexible and is in compression during rotation of components 26, 28. Bridge 960 allows for variations in loads between first leg 920 and second leg 922. Bridge 960 provides seal flexibility between first leg 920 and second leg 922 and allows second leg 922 to maintain dynamic sealing against cup 40 during rotation of components 26, 28. Cavity 962 facilitates relative movement between first and second legs 920, 922 and allows cup 40 to have some radial movement and to realign itself when necessary. Cavity 962 also functions as a reservoir for grease. The compressible nature of bridge 960 also allows for limited axial movement between cup 40 and trunnion 36. Axial movement may also be restricted by the engagement of spacer 886 with cup 40 and trunnion 36.

Bridge 960, as stated above, acts as the biasing member in the fourth preferred embodiment. Bridge 960 exhibits both spring and damping characteristics. The engagement between first leg 920 and trunnion 36 limits the degree to which seal 842, and its associated cup assembly 22, can be positioned onto the associated trunnion 36. As a result, bridges 960 can be axially preloaded/compressed by retaining cup assemblies 22 within yokes 25 with clips 41. Bridges 960 allow for limited relative movement between cup assemblies 22 and trunnions 36 during rotation of U-joint 20. The spring rate and damping characteristics will vary based upon the geometry and materials of bridges 960.

A first alternate embodiment of the fourth preferred embodiment is shown in FIGS. 13A and 13B. In the first alternate embodiment, a biasing bridge 1060 has a biasing coil spring 1062 disposed therein between first insert 1146 and second insert 848. Bridge 1060 and coil spring 1062 work in combination to form the biasing member. Coil Spring 1062 and bridge 1060 are axially preloaded/compressed between cup 40 and trunnion 36 when U-joint 20 is assembled. Coil spring 1062 and bridge 1060 allow for limited movement between cup assemblies 22 and trunnions 36 during rotation of U-joint 20. Coil spring 1062 can be made from the same materials as first and/or second inserts 1150, 848 or from other materials. First insert 1146 has a flat section 1150 extending radially outwardly from straight section 978. Flat section 1150 engages a top portion 1154 of coil spring 1062. A top section 1156 of second insert 848 engages a bottom portion 1158 of coil spring 1062. It should be appreciated that second insert 848 may be modified to include an extension or projection (not shown) that extends axially from top section 1156 to limit the radial movement of coil spring 1062. It should be appreciated that different coil configurations can be utilized.

The first alternate embodiment (shown in FIGS. 13A and 13B) of the fourth preferred embodiment may be modified further as shown in FIGS. 13C and 13D. In a second alternate embodiment of the fourth preferred embodiment, as shown in FIG. 13C, a biasing insert 1162 that extends between first and second inserts 1146, 848 is utilized. Biasing insert 1162 is disposed in bridge 1060 of seal 842 in place of coil spring 1062. Bridge 1060 and biasing insert 1162 work in combination as the biasing member. Insert 1162 and bridge 1060 are axially preloaded/compressed between cup 40 and the trunnion 36 when U-joint 20 is assembled. Insert 1162 and bridge 1060 allow for limited movement between cup assemblies 22 and trunnions 36 during rotation of U-joint 20. The biasing insert includes a plurality of webs 1164 extending between top and bottom rings 1166, 1168. A plurality of openings 1170 are disposed between webs 1164. Radial webs 1164 curve radially as they extend axially. Flat section 1150 of first insert 1146 engages top ring 1166 of insert 1162. Top section 1156 of second insert 848 engages bottom ring 1168 of insert 1162. It should be appreciated that second insert 848 may be modified to include an extension or projection (not shown) that extends axially from top section 1156 to limit the radial movement of biasing insert 1162. The material of biasing insert 1162 may be the same, but is not limited to, the material used in first and second inserts 1146, 848. The number, size, and shape of webs 1164 will vary based upon the desired spring and damping characteristics. It should be appreciated that first and second inserts 1146, 848 and biasing insert 1162 may be provided as a single integral component, such as by stamping or other manufacturing method.

In a third alternate embodiment of the fourth preferred embodiment, as shown in FIG. 13D, a differently-configured insert 1262 that extends between first and second inserts 1146, 848 is utilized. Biasing insert 1262 is disposed in bridge 1060 of seal 842. Bridge 1060 and biasing insert 1262 work in combination as the biasing member. Biasing insert 1262 and bridge 1060 are axially preloaded/compressed between cup 40 and trunnion 36 when U-joint 20 is assembled. Biasing insert 1262 and bridge 1060 allow for limited movement between cup assemblies 22 and trunnions 36 during rotation of U-joint 20. Biasing insert 1262 includes a plurality of spiral webs 1264 that extend between top and bottom rings 1266, 1268. There is a plurality of openings 1270 between spiral webs 1264. Spiral webs 1264 curve around axial axis 38b as they extend both axially and radially. Flat section 1150 of first insert 1146 engages top ring 1266 of biasing insert 1262. Top section 1156 of second insert 848 engages bottom ring 1268 of biasing insert 1262. It should be appreciated that second insert 848 may be modified to include an extension or projection (not shown) that extends axially from top section 1156 to limit the radial movement of biasing insert 1262. The material of biasing insert 1262 may be the same as, but is not limited to, the material used in first and second inserts 1146, 848. The number, size, and shape of spiral webs 1264 will vary based upon the desired spring and damping characteristics. It should be appreciated that first and second inserts 1146, 848 and biasing insert 1262 may be provided as a single integral component, such as by stamping or other manufacturing method.

The preceding description of the present invention refers to specific configurations and orientations for the various embodiments. It should be appreciated, however, that deviations, changes and alterations to the present invention can be employed without departing from the spirit and scope of the present invention. For example, a combination of the various biasing members described above may be utilized in a single U-joint assembly and/or U-joint 20. One possible combination, by way of a non-limiting example, is utilizing the seal of the fourth preferred embodiment in conjunction with the belleville washer of the second preferred embodiment. Additionally, while the fourth preferred embodiment is shown as having two annular inserts within the legs of the retaining member, it should be appreciated that additional inserts may be employed. Additionally, while the U-joint is shown as coupling two components 26, 28 together, it should be appreciated that the U-joint of the present invention is not limited to shafts, but can be used to couple other types of rotating members together. Moreover, the spiral configuration for biasing inserts 1162, 1262 can vary from that shown.

Thus, the description of the invention is merely exemplary in nature and variations that do not depart from the gist of the invention are intended to be within the scope of the invention. Such variations are not to be regarded as a departure from the spirit and scope of the invention.

What is claimed is:

1. A U-joint system comprising:
a cup operable to be disposed on a trunnion;
a sealing member operable to form a seal between the cup and a trunnion;
at least one bearing disposed in the cup; and
a biasing member applying an axial static preload of a predetermined magnitude between the cup and a trunnion, the biasing member resisting compression and allowing limited relative movement between the cup and a trunnion.

2. The U-joint system of claim 1, wherein the biasing member is a spring disposed between the cup and a trunnion.

3. The U-joint system of claim 2, wherein the spring member is annular, a first portion of the spring member contacts a bottom surface of the cup and a second portion of the spring member contacts a bottom of a trunnion.

4. The U-joint system of claim 3, wherein the first portion is a radially innermost portion.

5. The U-joint system of claim 3, wherein the second portion is a radially innermost portion.

6. The U-joint system of claim 3, wherein one of the first and second portions is an axially flat portion and the other one of the first and second portions extends axially from the flat portion.

7. The U-joint system of claim 2, further comprising a contacting member disposed between and directly contacting the spring member and a trunnion.

8. The U-joint system of claim 7, wherein the contacting member contacts an axial center portion of a trunnion.

9. The U-joint system of claim 8, wherein a shape of a contacting surface of the contacting member is complementary to the axial center portion of the trunnion.

10. The U-joint system of claim 7, wherein the contacting member is PTFE.

11. The U-joint assembly of claim 2, wherein the spring member is a coil spring.

12. The U-joint system of claim 2, wherein the spring member is a belleville washer.

13. The U-joint system of claim 2, wherein the spring member is an undulating washer.

14. The U-joint system of claim 1, wherein the biasing member is an elastomeric material.

15. The U-joint system of claim 14, wherein the biasing member includes an axially extending portion that extends into and applies an axial preload against an axially extending cavity in a trunnion.

16. The U-joint system of claim 15, wherein said axially extending portion includes a central axially extending through channel.

17. The U-joint system of claim 15, wherein said axially extending portion includes a plurality of radially extending fins.

18. The U-joint system of claim 1, wherein the biasing member has damping characteristics and is operable to damp relative movement between the cup and a trunnion over a predetermined frequency range during rotation of the U-joint system.

19. The U-joint system of claim 1, wherein the biasing member has a spring rate of a predetermined value, and the biasing member is operable to damp relative movement between the cup and a trunnion over a predetermined frequency range during rotation of the U-joint system.

20. The U-joint system of claim 1, wherein the biasing member has a progressive spring rate that changes with compression of the biasing member.

21. The U-joint system of claim 1, wherein the biasing member is at least partially disposed in the sealing member.

22. A self-aligning U-joint comprising:
a spider having a center with a plurality of trunnions extending therefrom;
a pair of yokes each having arms within which the trunnions are disposed;
a plurality of cup assemblies, each cup assembly disposed on one of the trunnions and within one of the yoke arms, each cup assembly including:
(i) a rigid cup;
(ii) a sealing member operable to form a seal between the cup and the associated trunnion;
(iii) at least one bearing disposed in the cup; and
(iv) an aligning member operable to automatically align, to at least a predetermined standard, the cup relative to the associated trunnion when stationary and the aligning member allowing a limited temporary misalignment between the cup and the associated trunnion during rotation of the U-joint.

23. The self-aligning U-joint of claim 22, wherein the aligning member applies an axial static preload of at least a predetermined magnitude between the cup and the associated trunnion and resists compression.

24. The self-aligning U-joint of claim 23, wherein the aligning member is a spring member disposed between the cup and the associated trunnion.

25. The self-aligning U-joint of claim 24, wherein each trunnion has an axially centered chamber and the spring member is at least partially disposed within the chamber of the associated trunnion.

26. The self-aligning U-joint of claim 25, further comprising a contacting member disposed on the spring member and engaging with a top surface of the chamber of the associated trunnion, the contacting member having a contacting surface that is complementary to the top surface of the chamber of the associated trunnion.

27. A U-joint system comprising:
a cup operable to be disposed on a trunnion;
at least one bearing disposed in the cup; and
a sealing assembly operable to form a seal between the cup and a trunnion upon which the cup is disposed, the sealing assembly including:
(i) a first sealing portion forming a seal against the cup;
(ii) a second sealing portion forming a seal against a trunnion upon which the cup is disposed; and
(iii) a biasing member applying an axial static preload of a predetermined magnitude between the cup and a trunnion upon which the cup is disposed, the biasing member resisting compression and allowing limited relative movement between the cup and a trunnion upon which the cup is disposed.

28. The U-joint system of claim 27, wherein a flexible bridge interconnects the first and second sealing portions and the biasing member is at least partially disposed in the bridge.

29. The U-joint system of claim 28, further comprising:
a first rigid annular member at least partially disposed within the first sealing portion and limiting radial movement of the first sealing portion; and
a second rigid annular member at least partially disposed within the second sealing portion and limiting radial movement of the second sealing portion,
wherein the biasing member is a plurality of webs disposed between the first and second annular members.

30. The U-joint system of claim 29, wherein the plurality of webs are spiral webs.

31. The U-joint system of claim 28, further comprising:
a first rigid annular member at least partially disposed within the first sealing portion and limiting radial movement of the first sealing portion; and
a second rigid annular member at least partially disposed within the second sealing portion and limiting radial movement of the second sealing portion,
wherein the biasing member is a coil spring disposed between the first and second annular members.

32. The U-joint system of claim 27, wherein the first sealing portion forms a dynamic seal against the cup and the second sealing portion forms a static seal against a trunnion upon which the cup is disposed.

33. The U-joint system of claim 27, wherein the biasing member is metal.

34. The U-joint system of claim 27, wherein the biasing member is a flexible bridge that interconnects the first and second sealing portions.

35. A method of damping vibration of a U-joint assembly, the method comprising:
(a) axially preloading a cup assembly on a trunnion within the U-joint assembly;
(b) compressing a biasing member with the axial preloading;
(c) allowing limited relative movement between the trunnion and the cup assembly during rotation of the U-joint assembly; and
(d) damping the relative movement between the trunnion and the cup assembly with the biasing member during rotation of the U-joint assembly.

36. The method of claim 35, wherein the biasing member is a spring member disposed between a cup of the cup assembly and the trunnion and (b) includes compressing the spring member between the trunnion and the cup of the cup assembly.

37. The method of claim 35, wherein the biasing member is an elastomeric material disposed between a cup of the cup assembly and the trunnion and (b) includes compressing the elastomeric material between the trunnion and the cup of the cup assembly.
